(19) United States
(12) Patent Application Publication
(10) Pub. No.: US 2013/0097919 A1
(43) Pub. Date: Apr. 25, 2013

(54) SLUG BAIT DISPENSER

(71) Applicant: SUSAN FERRO, PORTLAND, OR (US)

(72) Inventor: SUSAN FERRO, PORTLAND, OR (US)

(21) Appl. No.: 13/659,701

(22) Filed: Oct. 24, 2012

Related U.S. Application Data
(60) Provisional application No. 61/551,212, filed on Oct. 25, 2011.

(51) Int. Cl. A01M 25/00

(52) U.S. Cl. 43/124

(57) ABSTRACT

A slug bait dispenser having an elongated hollow dispensing tube at least two (2) feet in length but less than six (6) feet in length, having a removeable selectively closeable dispensing end. Dispensing end can further include a disc with a plurality of apertures, and a turning cap having an open portion and a closed portion which, upon turning, aligns said open portion with said apertures to open said dispensing end and can further be turned to align said closed portion with said apertures to close said dispensing end. In another embodiment, dispensing end includes a plurality of apertures and a protruding tamping heel.

### CROSS REFERENCE TO RELATED APPLICATION

Applicant claims priority to co-pending provisional application Ser. No. 61/551,212, filed Oct. 25, 2011, and incorporated herein by this reference.

### FIELD OF THE INVENTION

The present invention relates to devices and apparatuses for treating garden pests. More particularly, the present invention relates to dispensers for treating garden pests in hard to reach spots

### BACKGROUND

Slugs are a common gardening problem. Slug trails can frequently be in hard to reach places, wet leafy areas away from paths and lawn. Slugs are often treated often with slug bait, which requires reaching into the hard to reach places and shaking the slug bait on the slugs and on the slug trails. Because of the location of these slugs and trails, the user frequently gets dirty, wet, and sometimes must strain significantly to reach the desired target.

### SUMMARY AND ADVANTAGES

Applicant's slug bait dispenser includes an elongated hollow dispensing tube at least two (2) feet in length but less than six (6) feet in length, having a removeable selectively closeable dispensing end. Dispensing end can further include a disc with a plurality of apertures, and a turning cap having an open portion and a closed portion which, upon turning, aligns said open portion with said apertures to open said dispensing end and can further be turned to align said closed portion with said apertures to close said dispensing end. In another embodiment, dispensing end includes a plurality of apertures and a protruding tamping heel.

The slug bait of the present invention presents numerous advantages, including: (1) can remove the dispensing end to easily fill with slug bait; (2) in one embodiment, can selectively open and close the dispensing end; (3) enables reaching hard to reach, dirty, wet garden spots to dispense slug bait on slug trails; (4) enables dispensing slug bait without having to bend down. Additional advantages of the invention will be set forth in part in the description which follows, and in part will be obvious from the description, or may be learned by practice of the invention. The advantages of the invention may be realized and attained by means of the instrumentalities and combinations particularly pointed out in the appended claims. Further benefits and advantages of the embodiments of the invention will become apparent from consideration of the following detailed description given with reference to the accompanying drawings, which specify and show preferred embodiments of the present invention.

### BRIEF DESCRIPTION OF THE DRAWINGS

The accompanying drawings, which are incorporated into and constitute a part of this specification, illustrate one or more embodiments of the Applicant's slug bait dispenser and, together with the detailed description, serve to explain the principles and implementations of the invention.

FIG. 1 shows Applicant's slug bait dispenser in use.

FIG. 2 shows a view of a portion of a slug bait dispenser being filled with slug bait.

FIG. 3 shows another view of a portion of a slug bait dispenser.

FIG. 4 shows a view of a slug bait dispenser.

FIG. 5 shows another view of a slug bait dispenser.

FIG. 6 shows a view of a slug bait dispenser showing the action of the selectively closeable dispensing end of said dispenser.

FIG. 7 shows the selectively closeable dispensing end of a slug bait dispenser in the open position.

FIG. 8 shows the selectively closeable dispensing end of a slug bait dispenser in the closed position.

FIG. 9 shows another view of a slug bait dispenser.

FIG. 10 shows the dispensing end of a slug bait dispenser having a tamping heel.

FIG. 11 shows a perspective view of the dispensing end of a slug bait dispenser having a tamping heel.

FIG. 12 shows the outside view of the attachable dispensing end of a slug bait dispenser having a tamping heel, removed from the slug bait dispenser.

FIG. 13 shows the inside view of the attachable dispensing end of a slug bait dispenser having a tamping heel, removed from the slug bait dispenser.

### DETAILED DESCRIPTION

Before beginning a detailed description of the subject invention, mention of the following is in order. When appropriate, like reference materials and characters are used to designate identical, corresponding, or similar components in differing figure drawings. The figure drawings associated with this disclosure typically are not drawn with dimensional accuracy to scale, i.e., such drawings have been drafted with a focus on clarity of viewing and understanding rather than dimensional accuracy.

In the interest of clarity, not all of the routine features of the implementations described herein are shown and described. It will, of course, be appreciated that in the development of any such actual implementation, numerous implementation-specific decisions must be made in order to achieve the developer's specific goals, such as compliance with application- and business-related constraints, and that these specific goals will vary from one implementation to another and from one developer to another. Moreover, it will be appreciated that such a development effort might be complex and time-consuming, but would nevertheless be a routine undertaking of engineering for those of ordinary skill in the art having the benefit of this disclosure.

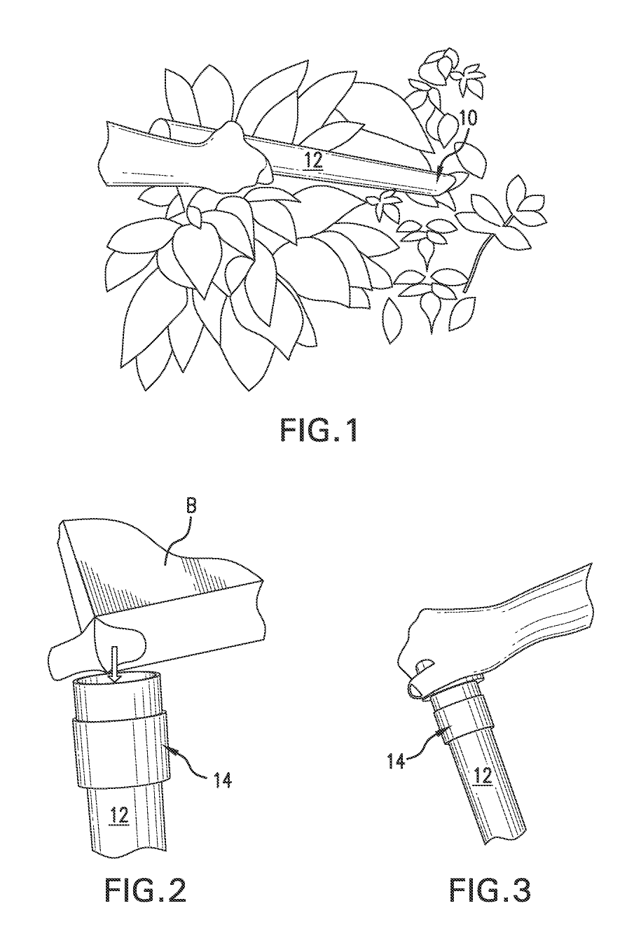

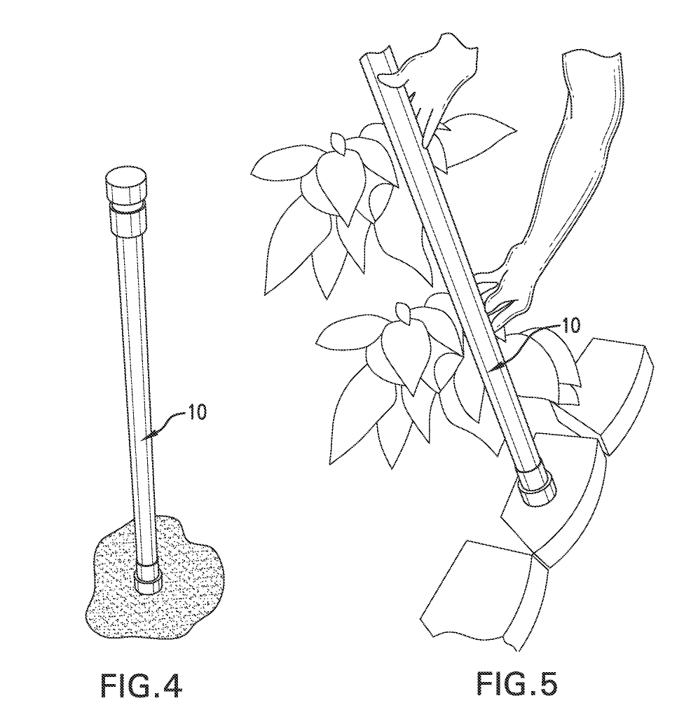

Applicant provides a dispenser 10 for slug bait B. As shown in FIGS. 1-8, a slug bait dispenser 10 includes an elongated hollow dispensing tube 12 at least two (2) feet in length but less than six (6) feet in length, having a removeable selectively closeable dispensing end 14. Dispensing end 14 can further include a disc with a plurality of apertures 16, and a turning cap 18 having an open portion 18b and a closed portion 18a which, upon turning, aligns said open portion 18b with said apertures 16 to open said dispensing end 14 and can further be turned to align said closed portion 18a with said apertures 16 to close said dispensing end 14. In another embodiment 20, dispensing end 22 includes a removable cap 24 having a plurality of apertures 28 and a protruding tamping heel 26.

In a preferred embodiment, the dispensing end screws off for slug bait to be poured in. The dispensing end has a plurality of dispensing apertures that can be opened or closed by rotating a cap on the end. The dispenser includes a long hollow tube, preferably two (2) feet to six (6) feet long.

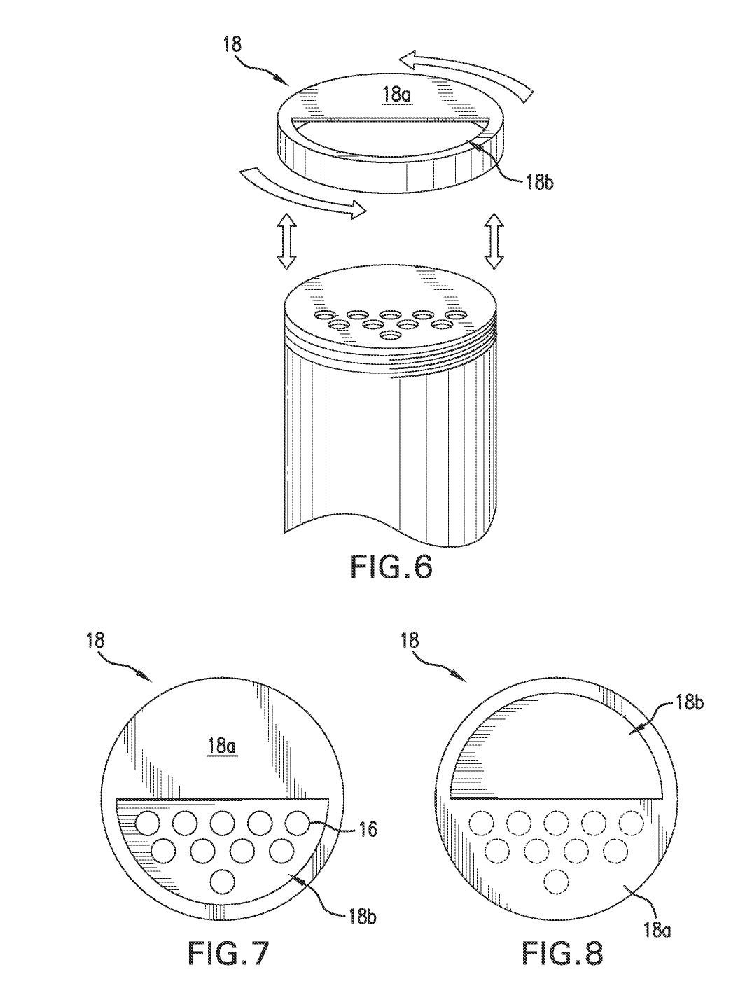

FIG. 1 shows Applicant's slug bait dispenser 10 in use. FIG. 2 shows a view of a portion of Applicant's slug bait dispenser 10 being filled with slug bait B. FIG. 3 shows another view of a portion of Applicant's slug bait dispenser 10, with the dispensing end 14 in the process of being screwed off. Dispensing end 14 can be provided with a turning cap 18 for selectively closing the dispensing end 14 FIG. 6 shows a view of Applicant's slug bait dispenser 10 showing the action of the selectively closeable dispensing end 14, 18 of said dispenser. FIG. 7 shows the selectively closeable dispensing end 14, 18 of Applicant's slug bait dispenser 10 in the open position. FIG. 8 shows the selectively closeable dispensing end 14, 18 of Applicant's slug bait dispenser 10 in the closed position.

In operation, user unscrews the turning cap 18 on dispensing end 14, and pours slug bait B into the elongated tube 12, and then screws the dispensing end turning cap 18 back on to seal the slug bait B in the dispenser 10. User then turns the selectively closeable dispensing end 14 by rotating the turning cap 18 to open the apertures 16 for dispensing. User then uses the length of the elongated dispenser 10 to place the dispensing end 14 in proximity to the hard to reach slug trails and dispenses the slug bait B, shaking if necessary.

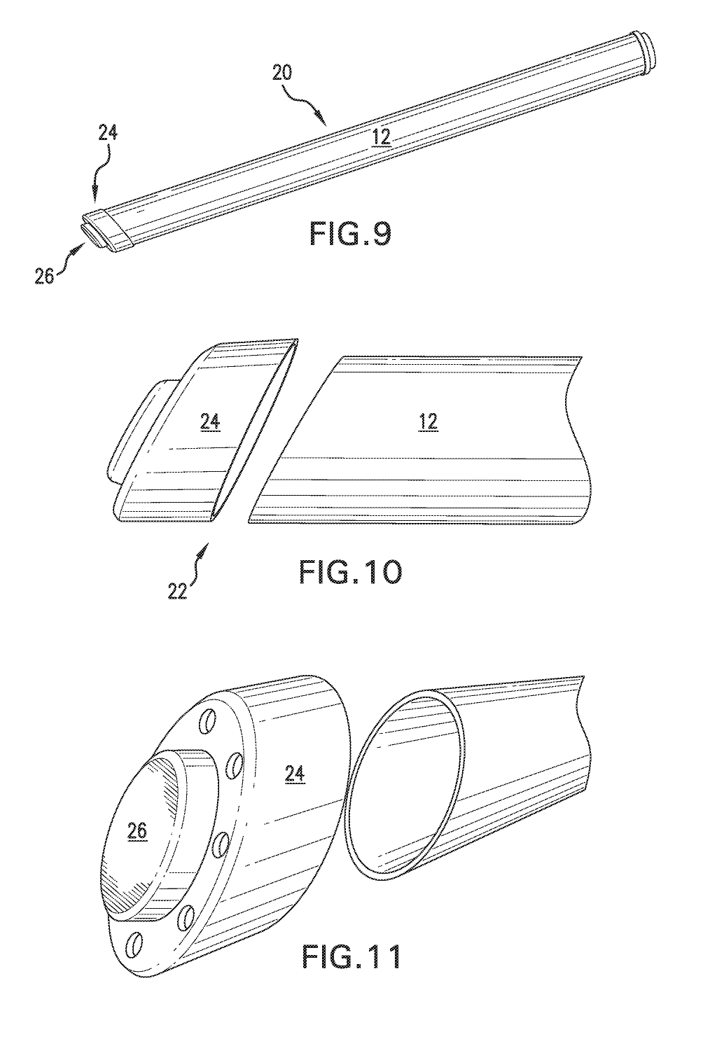

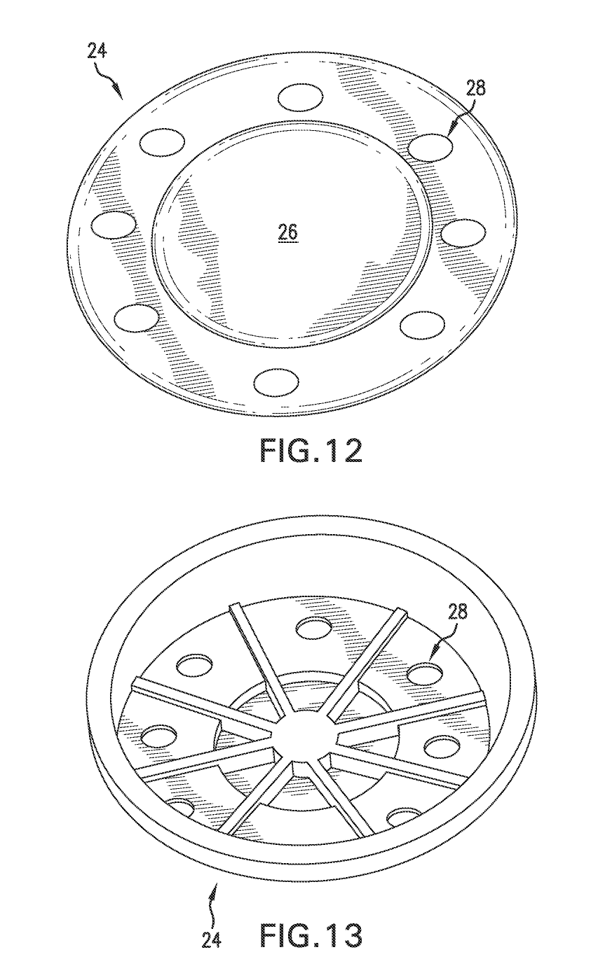

In another embodiment, as shown in FIGS. 9-13, dispensing end 22 is provided removable cap 24 with a plurality of apertures 28 and a tamping heel 26. Dispensing end 22 removable cap 24 screws on and off the slug bait dispenser. Those of skill in the art know that the attachment method can include mating screw threads on the dispensing end and removable cap, or alternatively, as shown, friction-fitting. In operation, the user fills the slug bait dispenser 20 with slug bait B, and tamps the slug bait dispenser on the ground on the tamping heel 26 to shake slug bait out of the apertures 28.

Those of skill in the art will recognize that the slug bait dispenser can be made of any of a number of suitable materials, including among others, without limitation, wood, metal, plastic, pvc, and rubberized materials.

Those skilled in the art will recognize that numerous modifications and changes may be made to the preferred embodiment without departing from the scope of the claimed invention. It will, of course, be understood that modifications of the invention, in its various aspects, will be apparent to those skilled in the art, some being apparent only after study, others being matters of routine mechanical, chemical and electronic design. No single feature, function or property of the preferred embodiment is essential. Other embodiments are possible, their specific designs depending upon the particular application. As such, the scope of the invention should not be limited by the particular embodiments herein described but should be defined only by the appended claims and equivalents thereof.

I claim:

1. A slug bait dispenser, comprising an elongated hollow dispensing tube at least two (2) feet in length but less than six (6) feet in length, having a removeable selectively closeable dispensing end.

2. The slug bait dispenser of claim 1, further including slug bait within said tube.

3. A slug bait dispenser, comprising an elongated hollow dispensing tube at least two (2) feet in length but less than six (6) feet in length, having a removeable selectively closeable dispensing end, and wherein said dispensing end includes a disc with a plurality of apertures, and a turning cap having an open portion and a closed portion which, upon turning, aligns said open portion with said apertures to open said dispensing end and can further be turned to align said closed portion with said apertures to close said dispensing end.

4. The slug bait dispenser of claim 3, further including slug bait within said tube.

5. A slug bait dispenser, comprising an elongated hollow dispensing tube at least two (2) feet in length but less than six (6) feet in length, having a dispensing with a removable cap having a plurality of apertures and a tamping heel.

6. The slug bait dispenser of claim 5, further including slug bait within said tube.
